(19) United States
(12) Patent Application Publication
(10) Pub. No.: US 2009/0159390 A1
(43) Pub. Date: Jun. 25, 2009

(54) Friction one-way clutch

(75) Inventor: Michael C. Davis, Sterling, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/316,219

(22) Filed: Dec. 10, 2008

Related U.S. Application Data
(60) Provisional application No. 61/008,285, filed on Dec. 19, 2007.

(51) Int. Cl. F16D 41/06

(52) U.S. Cl. 192/45.1

(57) ABSTRACT

The present invention is a friction one-way clutch that may be used with automotive components such as a stator in a torque converter. The clutch includes a circular outer race attached to the stator, a flat wedge ring having at least one wedge and fit into an inner perimeter of the outer race to form an interference fit with the outer race. The interference fit is formed by a wedge angle between the inner perimeter of the outer race and the outer perimeter of the wedge ring. An inner race with at least part of its outer edge formed by one or more tapered ramps fits into the inner circumference of the wedge ring. The inner race is attached by splines to a stator shaft. The components of the clutch are positioned so that if they are turned in one direction, the friction between the components will prevent the stator from continuing to turn in that direction. If the components are turned in the opposite direction, the stator is allowed to turn freely. Also provided is a method of calculating the shape of the wedge ring that allows the wedge ring to break away from the lock up condition using no or negligible force.

### CROSS-REFERENCE TO RELATED APPLICATIONS

This application claims the benefit under 35 U.S.C. §119(e) of U.S. Provisional Application No. 61/008,285 filed on Dec. 19, 2007 and is incorporated herein by reference.

### FIELD OF THE INVENTION

The present invention relates generally to the field of stators utilized in torque converters, more specifically to one-way or unidirectional clutches for stators and still more specifically to friction one-way clutches used with stators.

### BACKGROUND OF THE INVENTION

In transmissions, it is common to use a one-way clutch to provide a single direction of rotational motion. One-way clutches for torque converter stators commonly use either roller or sprag clutches. Both of these designs result in high stress due to line contact between the components. As a result, the components must have a minimum length to withstand the stresses. The minimum length creates a need for larger components which increase the cost of the one-way clutch.

U.S. Pat. No. 4,341,294 to Kerr discloses a spiral type one-way clutch assembly that includes utilizing monolithic annular outer and concentrically positioned annular inner body members which have mutually opposed tangentially congruent spiral surfaces defining a spiral race positioned between them. A plurality of axially oriented abutting roller members is positioned in, and almost fills, the spiral race, with each roller member being in contact with both the inner and outer spiral surfaces. Limit springs are placed between the body members to limit the relative oscillatory movement between the body members.

U.S. Pat. Nos. 3,107,764 and 3,202,250, both to Fulton, disclose a friction one-way clutch that uses a spiral similar to that seen in Kerr. The rollers in Kerr are replaced with friction modifiers in the form of wedges. However, the clutches disclosed in the Fulton patents use multiple springs and multiple wedges which add to the cost of manufacturing. The also possess a complex geometry on the contact surfaces of the various components.

Although the clutches discussed above provide unidirectional movement to stators in torque converters, they are both complex assemblies in terms of both number of parts and length of contact components. In addition, they are relatively costly to produce.

Thus, there exists a need in the field for a friction one-way clutch for torque converter stators that is comprised of a minimum of parts that are easily and cheaply manufactured and assembled.

### SUMMARY OF THE INVENTION

The present invention broadly comprises a friction one-way clutch comprising a flat outer race, the outer race having an inner circumference and an outer circumference; a flat wedge ring, the wedge ring having at least one tapered wedge that forms at least part of an inner circumference of the wedge ring and an outer circumference having a radius offset at any point on the outer circumference, wherein the wedge ring forms an interference fit with the inner circumference of the outer race; and, a flat inner race, the inner race having an inner circular perimeter and an outer perimeter, in which the outer edge is generally round and formed into at least one tapered ramp. By generally round is meant that the overall shape of the outer edge is round but may not form a perfect circle. The at least one ramp of the inner race contacts at least one of the at least one tapered wedges to form at least one friction point when the clutch rotates in one direction.

The present invention also comprises a torque converter stator—one way friction clutch assembly comprising a torque converter stator; a flat outer race, in which the outer race includes an inner circumference and an outer circumference and is attached to the stator; a flat wedge ring, in which the wedge ring possesses at least one tapered wedge that forms at least part of an inner circumference of the wedge ring and an outer circumference having a radius offset at any point on the outer circumference, wherein the wedge ring forms an interference fit with the inner circumference of the outer race; and a flat inner race, the inner race having an inner circular perimeter and an outer perimeter, wherein the outer perimeter is generally round and formed into at least one tapered ramp. The at least one ramp of the inner race contacts at least one of the at least one tapered wedges to form at least one friction point when the inner race is rotated in one direction.

The invention also comprises a method of shaping a wedge ring of a one-way clutch comprising: determining the inner radius of the wedge ring; determining the outer radius of the wedge ring; establishing the coefficient of friction between the wedge ring and an inner race of the one-way clutch; calculating the range of lock up wedge angles between the wedge ring and the inner race, wherein the lock up angle range allows the one-way clutch to break away from the lock up with negligible force; and, shaping the wedge ring to have a wedge angle within the angle range when locked up with the inner race.

One object of the present invention is to present a one-way or unidirectional friction clutch with a reduced number of parts.

A second object of the invention is to provide a one-way unidirectional clutch comprising primarily stamped components.

A third object of the invention is to supply a one-way unidirectional clutch constructed in such a way as to reduce stress caused by line contact between components.

An additional object of the invention is to reduce the over all length of the components of the friction one-way clutch needed to withstand the stresses of contact between the components.

A further object of the invention is to supply a method of shaping the wedge ring of the present invention by determining an optimal range of wedge angles based on known coefficients of friction between the outer race, the inner race and the wedge ring, and the inner and outer radii of the wedge ring.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is an exploded side perspective view of a stator found in the prior art showing a one-way clutch;

FIG. 2 is an exploded side perspective view of the friction one-way clutch of the present invention showing the alignment and orientation of the separate components of the cover, clutch and the stator;

FIG. 3 is a top view of the wedge ring of the friction one-way clutch of the present invention;

FIG. 4 is an exploded side perspective view of the components of an alternate embodiment of the friction one-way clutch of the present invention;

FIG. 5 is a top view of the friction one-way clutch of the present invention assembled from the components depicted in FIG. 4;

FIG. 6 is a cross section view of FIG. 5 taken along line A-A of FIG. 5;

FIG. 7 is a plan view of an alternate embodiment of the friction one-way clutch of the present invention;

FIG. 8 is a schematic partial view of the inner race and the wedge ring depicting the variables used to calculate lock up force and angle; and,

FIG. 9 is a schematic partial view of the inner race and the wedge ring depicting the variables used to calculate the angle ranges and radii for breakaway of the wedge ring from a lock up condition using no or negligible force.

### DETAILED DESCRIPTION OF PREFERRED EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

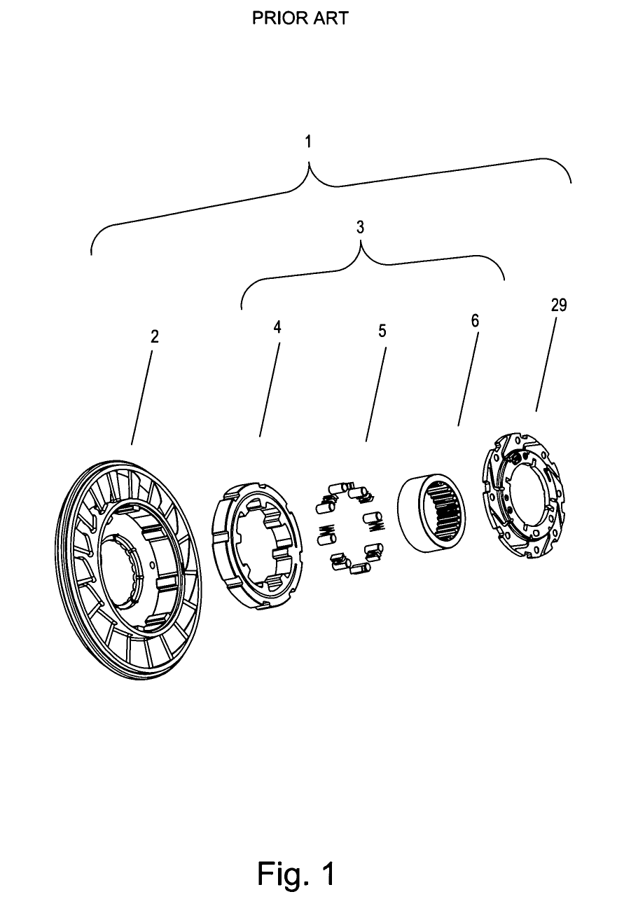

Adverting to the drawings, FIG. 1 is an exploded side perspective view of stator 1 found in the prior art showing one-way clutch 3. One way clutch 3 comprises outer race 4, a bearing/spring assembly 5, and circular inner race 6. Blade assembly 2 receives one-way clutch 3. Side plate 29 covers inner clutch 3 after it is placed into blade assembly 2.

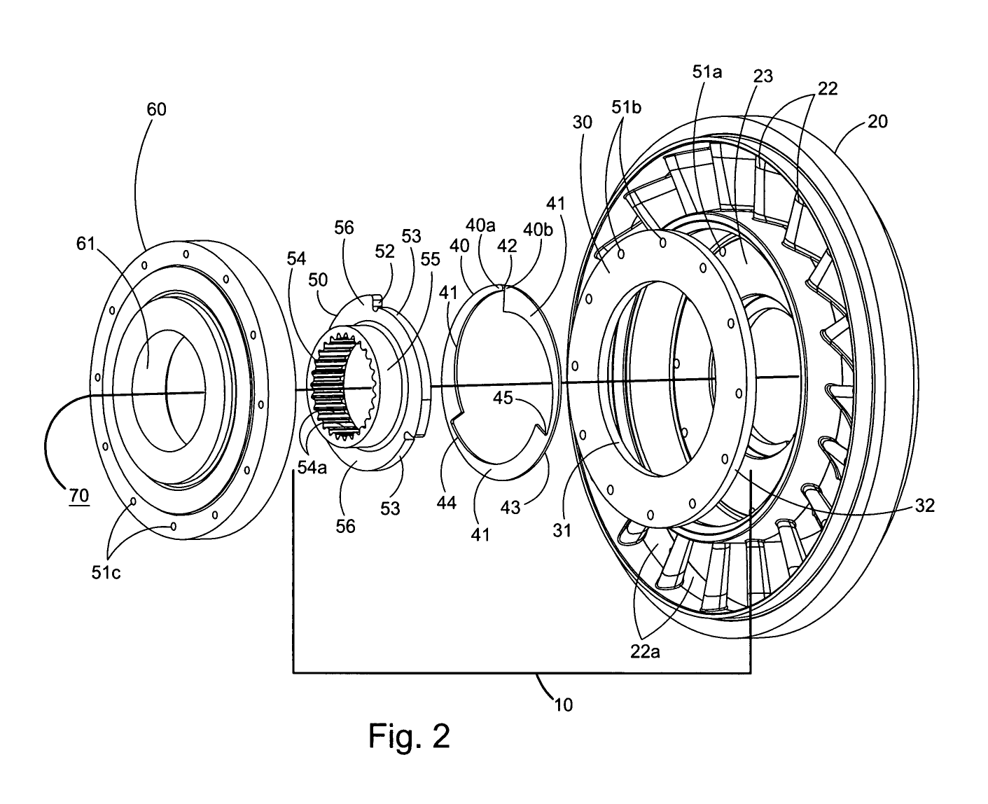

FIG. 2 is an exploded side perspective view of clutch 10 of the present invention and stator 20 showing the alignment and orientation of the separate components of clutch 10 with stator 20 when they are assembled together. Stator blades 22 are all seen slanted in the same direction to direct flow of transmission fluid from a torque converter turbine to a torque converter pump in a manner well known to those of skill in the art. FIG. 2 also depicts intervals 22a as uniform in shape and dimension and uniformly distributed around stator 20. Annular recess 23 is shaped to receive outer race 30 and defines stator holes 51a which are aligned with outer race holes 51b when clutch 10 is assembled with stator 20.

Outer race 30 preferably is a circular flat component having a round inner perimeter 31 and an outer perimeter 32. By flat is meant that the major surfaces of a particular component are essentially parallel and distinctly greater than the minor surfaces. Outer race 30 defines outer race holes 51b.

Wedge ring 40 is a flat generally round component that includes at least one tapered wedge 41 that projects from outer circumference 43 toward the inner space defined by inner circumference 44 to form at least part of inner circumference 44 of wedge ring 40. In one embodiment, wedge ring 40 may have a plurality of wedges 41 as seen in FIG. 2. Gap 42 forms a separation in outer circumference 43 between wedge ring ends 40a and 40b. Wedge ring 40 is sized so that it is able to form an interference fit with inner perimeter 31 of outer race 30 when it is placed inside of inner perimeter 31 of outer race 30. In one embodiment, the outer diameter of wedge ring 40 is greater than the inner diameter of outer race 30. Thus, wedge ring 41 is fabricated to possess enough flexibility to be pressed into an interference fit within inner perimeter 31 and still retain the resiliency or “memory” to spring back forcefully to hold in position against inner perimeter 31. Suitable materials and fabrication methods are well known to those having skill in the art.

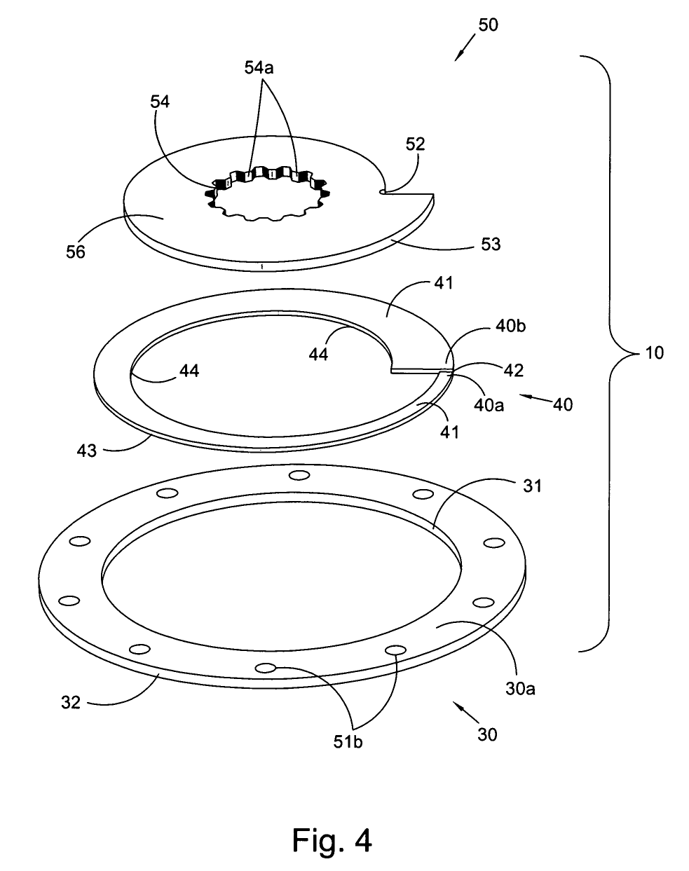

FIG. 2 also depicts inner race 50 as generally round and having at least one flat tapered ramp 56 that forms an outer edge 53. A ramp is defined as at least a tapered section such that the portion of inner race 50 that is part of one of ramps 56 increases in width from inner edge 54 of inner race 50 to outer edge 53 at the inner edge along the length of that ramp 56. In FIG. 2, angle 52 is seen formed in outer edge 53 between separate ramps 56. FIG. 2 depicts an embodiment of inner race 50 that comprises a plurality of ramps 56. In the embodiments shown in FIGS. 2 and 4, a plurality of splines 54a is distributed around inner edge 54. Persons of skill in the art will recognize that in alternate embodiments, inner edge 54 may not include splines 54a. FIG. 4 depicts an alternate embodiment in which inner race 50 comprises a single ramp 56.

FIG. 2 also depicts one embodiment of inner race 50 that includes a circular shaft housing 55 (“housing 55”) preferably integral with ramp(s) 56 and including an inner surface that forms an inner circular perimeter of inner race 50. Splines 54a project from the inner surface into passage 70 of housing 55 and extend along the length of the inner surface of housing 55. In this embodiment, ramp(s) 56 increases in width from housing 55 to outer edge 53.

Cover 60 covers the components of clutch 10 and defines holes 51c that are aligned with holes 51a and 51b during assembly to form a continuous passthrough or hole through which nut and bolt assemblies are passed to hold the clutch—stator assembly together. Cover 60 includes inner surface 61 which forms part of passage 70 with stator 20 and clutch 10.

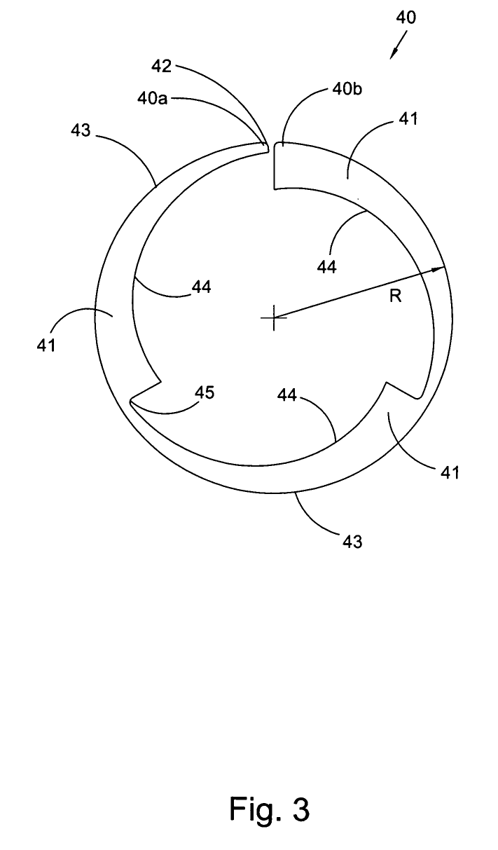

FIG. 3 is a top view of wedge ring 40 of clutch 10. The tapered shape of each of the plurality of wedges 41 is clearly seen. Radius R is an offset radius meaning that it is not uniform through the entire circumference of wedge ring 40. The offset may range from about a 0.05 mm to about a 0.2 mm difference through the circumference. In a preferred embodiment, the offset is about 0.1 mm. Also seen more clearly is gap 42 that allows wedge ring 40 to be placed within inner perimeter 31 of outer race 30. The offset radius enables wedge ring 40 to form an interference fit with inner perimeter 31 of outer race 30. In a preferred embodiment, gap 42 is located between the narrow end 40a of one wedge 41 and the widest end 40b of an adjacent wedge 41.

FIG. 4 is an exploded side perspective view of the components of an alternate embodiment of clutch 10. FIG. 4 shows the embodiment of wedge ring 40 having a single wedge 41 that forms the entire inner circumference 44 and outer circumference 43 of wedge ring 40. In this embodiment, gap 42 is formed by narrow end 40a of single wedge 41 and wide end 40b of the same wedge 41. Also seen in FIG. 4 is an embodiment of inner race 50 that is flattened such that shaft housing 55 is eliminated. In this embodiment, splines 54a form the inner perimeter 54 of inner race 50. It will be recognized that in this embodiment, inner race 50 is comprised of a single ramp 56.

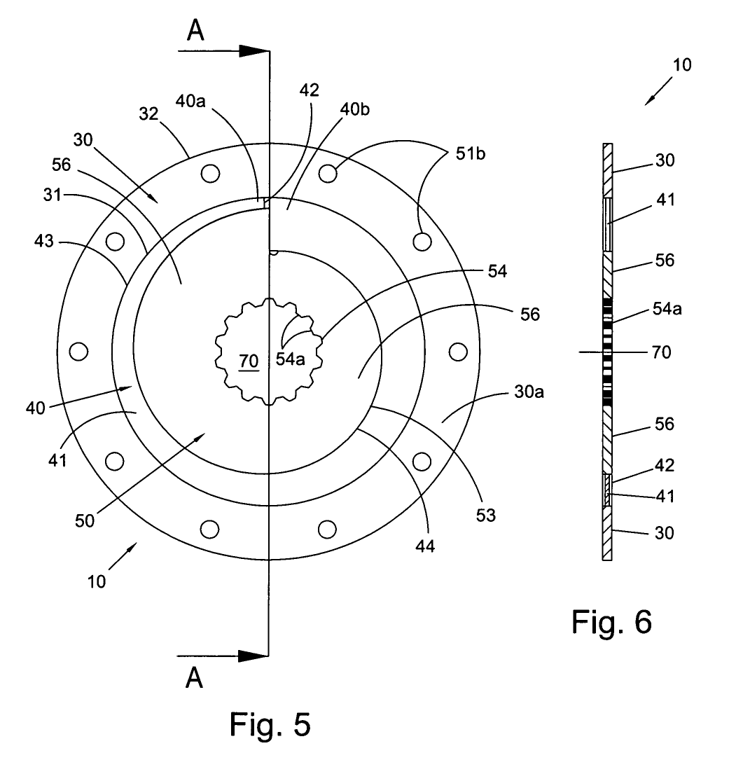

FIG. 5 is a top view of clutch 10 assembled from the components depicted in FIG. 4. It will be seen that both wedge ring 40 and inner race 50 each have a single wedge ring 41 and a single ramp 56, respectively. Gap 42 allows wedge ring 40 to fit within inner perimeter 31 of outer race 30. It can be seen that single tapered wedge 41 and single tapered ramp 56 are dimensioned so that inner race 50 fits closely within inner circumference 44 of wedge ring 40. The plurality of splines 54a forms passage 70. FIG. 6 is a cross section view of FIG. 5 taken along line A-A of FIG. 5.

Wedge 40 provides the advantage of distributing stress evenly inside of outer race 30. Friction is provided at one or more friction or contact points between wedge ring 40 and outer race 30 by offsetting outer perimeter 43 at any point on wedge ring 40. The offset creates an interference fit that creates the friction between outer race 30 and wedge ring 40. By adjusting the width of gap 42 the interference fit can be adjusted. Similarly, stress from friction between wedge ring 40 and inner race 50 is also evenly distributed inside of wedge ring 40 and inner race 50. Because this stress on all three components of clutch 10 is distributed throughout the body of each component, clutch 10 provides the advantage of enabling the manufacture of a friction one-way clutch using a less expensive method, such as stamping, as opposed to casting or forging and also allows for fewer parts to be fabricated and installed in the complete assembly.

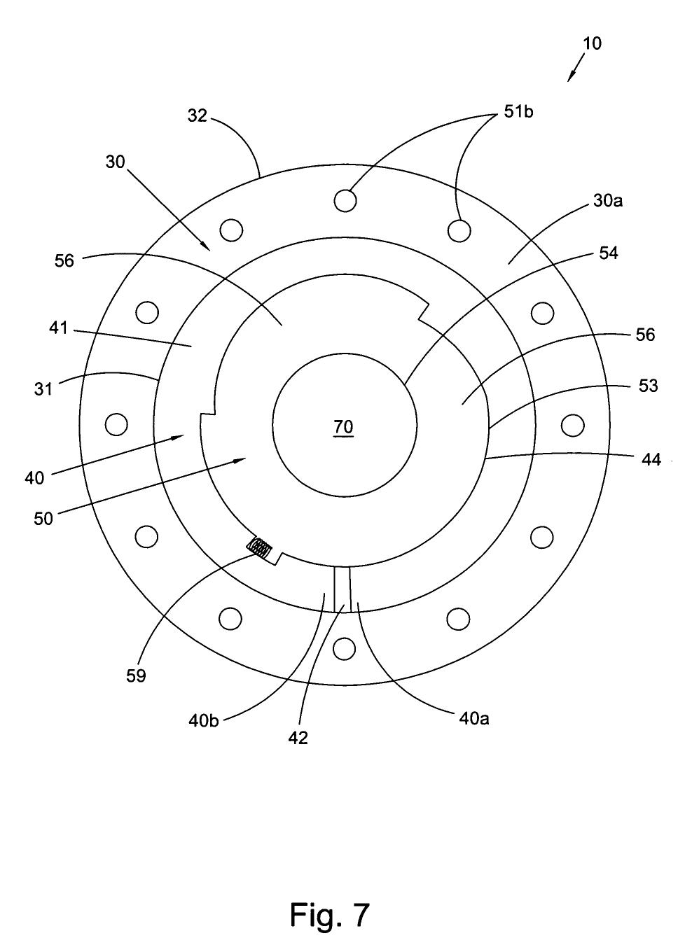

FIG. 7 is a plan view of an alternate embodiment clutch 10 in which spring 59 is placed between one end 40b of wedge ring 40 and one end of inner race 50. Spring 59 more easily enables clutch 10 to start the clutch locking process. It will be recognized by persons of skill in the art that in embodiments of clutch 10 having plurality of wedges 41 and ramps 56, springs 59 may be placed between more than one wedge 41—ramp 56 contact point.

Wedge ring 40 provides friction between outer race 30 and wedge ring 40 by using a spiral to create an offset angle. The outer diameter of wedge ring 40 is larger than the inner diameter of outer race 30 to stop the wedge ring from rotating in one direction. Preferably, the spiral on wedge ring 40 is an equal angular spiral which creates a constant angle across the entire surface. The constant angle is preferred for longer arcs to ensure proper contact is maintained at any given contact point. However, as the number of wedges 41 in wedge ring 40 increases, the amount of error in a non-equal angular spiral decreases which allows for the use of different shapes for wedges 41 as they get shorter in length.

One problem that may be encountered with clutch 10 is that wedge ring 40 may become frictionally wedged with outer race 30 in the lock up mode such that force may be necessary to dislodge wedge ring 40 from outer race 30 when clutch 10 enters the counterrotational or freewheeling mode. In a preferred embodiment, wedge ring 40 becomes dislodged without a minimal amount of force, meaning only negligible force, if any, is applied to enable “wedge ring” clutch 10 to begin to rotate in the opposite or freewheeling direction. Consequently, it is preferred that minimal or negligible force is used to lodge or “lock up” wedge ring 40.

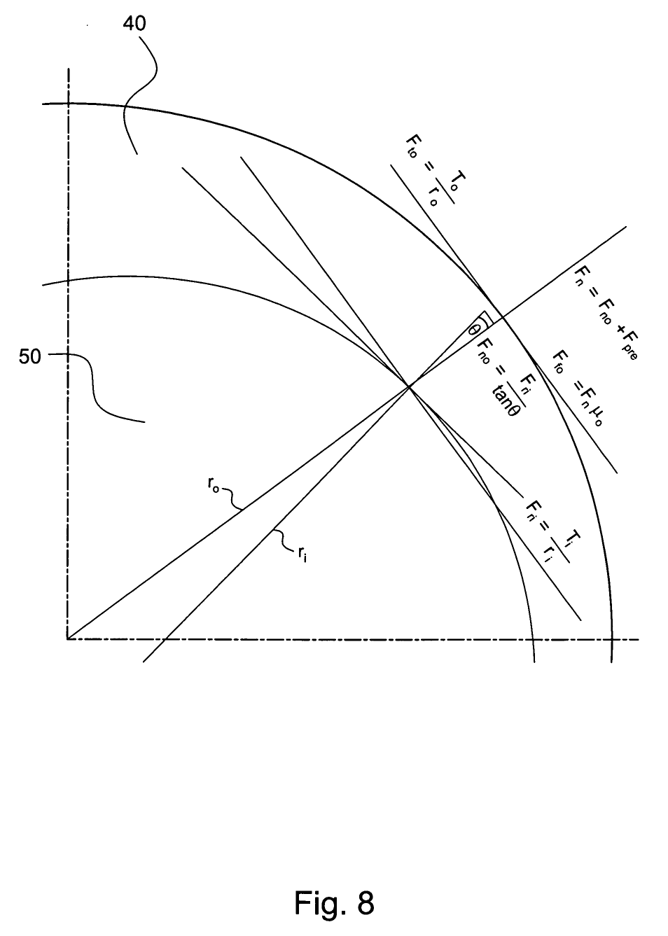

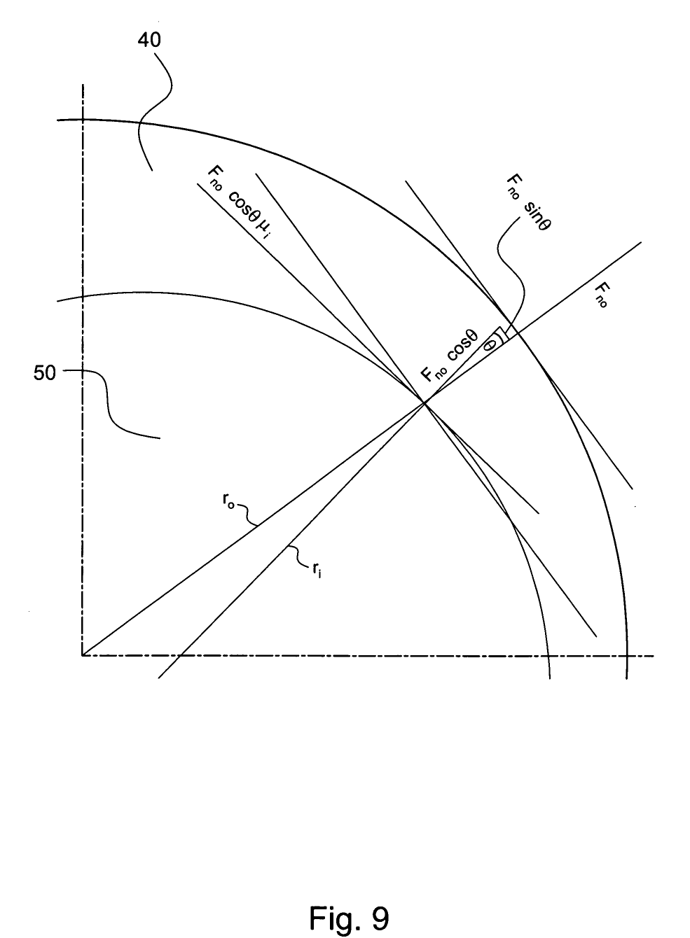

The relation of the frictional force (F_{fo}) of wedge ring 40 to the torque on outer race 30 and wedge angle θ can be seen as follows:

$$1. \frac{{T}_{o}}{{r}_{o}} < {F}_{n} {μ}_{o}$$

$$2. \frac{{T}_{o}}{{r}_{o}} < ( {F}_{no} + {F}_{pre} ) {μ}_{o}$$

$$3. \frac{{T}_{o}}{{r}_{o}} < ( {F}_{ri} / tan θ + {F}_{pre} ) {μ}_{o}$$

$$4. \frac{{T}_{o}}{{r}_{o}} < ( {T}_{i} / tan θ {r}_{i} + {F}_{pre} ) {μ}_{o}$$

where μₒ is the coefficient of friction between outer race 30 and wedge ring 40, θ is the wedge angle as seen in FIGS. 8 and 9, Tₒ is the torque on the outer edge of wedge ring 40, Tᵢ is the torque on the inner edge of wedge ring 40, rᵢ is the length of the inner radius of wedge ring 40, and rₒ is the length of the outer radius of wedge ring 40. Fₚᵣₑ is the force applied by the interference fit itself before wedge ring 40 is rotated in the lock-up direction. Compared to frictional force F_{fo} Fₚᵣₑ is minimal. Essentially, the frictional force F_{fo} of wedge ring 40 greatly enhances force Fₚᵣₑ that wedge ring 40 initially applies to outer race 30.

FIG. 8 shows the relation of the equations in which torque on outer race 30 (F_{fo}) must be less than the frictional force (F_{fo}) of wedge ring 40 on outer race 30 used to lock up wedge ring 40. It can be seen that the torque force on outer race 30 needs to be less than the frictional force on outer race 30 created by the inner surface of wedge ring 40. Preferably, the coefficient of friction between outer race 30 and wedge ring 40 should be as low as possible to ensure the least possible wear and loss of friction. Equation 1 allows a lock up clutch 10 to be designed with any coefficient of friction. A larger difference between wedge ring 40 inner radius (rᵢ) and outer radius (rₒ) improves locking ability of clutch 10 given a lower coefficient of friction or a shallower angle. Inner radius rᵢ is substantially equivalent to the radius of inner race 50. A shallow angle allows wedge ring 40 to become lodged or locked up with a minimal amount of friction force (Fₙₒ).

FIG. 9 shows the relation of the equations to determine the conditions to be met to allow wedge ring 40 to break away or dislodge freely, meaning with negligible force. This is derived as follows:

F_{fi}<Fₙₒ sin θ 5.

Fₙₒ cos θμᵢ<Fₙₒ sin θ 6.

μᵢ<sin θ/cos θ 7.

μᵢ<tan θ 8.

It can be seen that to achieve a free break away, the tangent of the wedge angle θ must be greater than the coefficient of friction μ between wedge ring 40 and inner race 50.

This shows that with a lower coefficient of friction μ, wedge angle θ can be reduced. For example, in the case of a stator for a torque converter, the radial area available to contain clutch 10 can be a limiting factor in terms of the size and configuration of the clutch. In order to adjust to a limited radial area, a shallow angle θ is preferred. This can be achieved using materials together that have a low coefficient of friction. Low coefficients of friction can be achieved using hardened materials that are coated using physical vapor deposition (PVD), chemical vapor deposition (CVD), nitride processes, or other suitable processes well known to those skilled in the art.

It will be recognized that clutch 10 may be adapted for use in a variety of contexts where use of a one-way clutch is desired. In automotive components, for example stators in torque converters, coefficients of friction μ may range from about 0.05 to about 0.25, inner radius rᵢ may range from about 25 mm to about 150 mm, and outer radius rₒ may range from about 50 mm to about 175 mm. It will be recognized however, that clutch 10 may be sized beyond these ranges when necessary to provide unidirectional control in a variety of automotive and other types of settings.

### EXAMPLE

In this example, the coefficient of friction μ is 0.2. This is similar to coefficients of friction found with typical materials that may be used in one-way clutches for stators, such as steel. As per equation 8, wedge angle θ must be greater than 11.31° (0.2<tan 11.31°). This will be the angle θ in lock up equation 4. Tₒ can be removed as Tₒ is larger than Tᵢ because it is at the outer radius. In addition, Fₚᵣₑ, the force generated by the wedge ring—outer race interference fit, is essentially zero as it is minimally sufficient to move wedge ring 40 into contact at all surfaces. Using the equation rᵢ<μrₒ/tan θ, 0.2 will be μ, rₒ is known to be 40.0 mm (a hypothetical but typical outer radius for wedge ring 40), and 11.5° for θ because it is larger than tan⁻¹μ. This gives an inner wedge radius rᵢ of less than 39.32 mm. Therefore to ensure clutch 10 breaks free with no torque applied, the wedge angle θ must be greater than 11.31° and to ensure the clutch locks we will have an outer wedge radius rₒ of 40.0 mm and an inner wedge radius of less than 39.32 mm.

It will be readily seen that a wedge angle range enabling both lock-up and “force-free” break away can be calculated from a revision of the equation to μᵢ<tan θ<μₒrₒ/rᵢ inserting the relevant inner radius and outer radius.

Because of the friction that develops between the components of clutch 10, it is preferred that harder materials be used in fabricating the components. For manufacturing purposes, a medium carbon steel, for example 1035 or 4140, hardened to about 40-65 Rockwell C is preferred for outer race 30 and inner race 50, while a high carbon, prehardened steel, such as 1075, is preferred for wedge ring 40.

Thus it is seen that the objects of the invention are efficiently obtained, although changes and modifications to the invention should be readily apparent to those having ordinary skill in the art, which changes would not depart from the spirit and scope of the invention as claimed.

I claim:

1. A friction one-way clutch comprising:
a flat outer race, said outer race having a circular inner perimeter and an outer perimeter;
a flat wedge ring, said wedge ring having an offset radius and at least one tapered wedge that forms at least part of an inner circumference of said wedge ring and an outer circumference having a gap, wherein said wedge ring forms an interference fit with said inner perimeter of said outer race; and,
an inner race, said inner race having an inner circular edge and an flat outer flange forming an outer edge, wherein said outer edge is generally round and formed into at least one tapered ramp;
wherein said at least one ramp of said inner race contacts at least one of said at least one tapered wedge to form at least one friction point when rotated in one direction.

2. The friction one-way clutch as recited in claim 1 wherein said wedge ring is shaped according to the formula μᵢ<tan θ<μₒrₒ/rᵢ in which θ is a wedge angle formed by the rotation of said wedge ring in the lockup direction to said outer race, μₒ is the coefficient of friction between said wedge ring and said outer race, μᵢ is the coefficient of friction between said wedge ring and said inner race, rₒ is the radius of said wedge ring, rᵢ is the inner radius of said wedge ring.

3. The friction one-way clutch as recited in claim 2 wherein said coefficients of friction μᵢ and μₒ range from about 0.05 to about 0.25, said outer radius ranges from about 50 mm to about 175 mm, and said inner radius ranges from about 25 mm to about 150 mm.

4. The friction one-way clutch as recited in claim 2 wherein said at least one tapered wedge is a plurality of tapered wedges.

5. The friction one-way clutch as recited in claim 2 wherein said at least one ramp is a plurality of ramps.

6. The friction one-way clutch as recited in claim 2 wherein said radius offset ranges from about 0.05 mm to about 0.2 mm.

7. The friction one-way clutch as recited in claim 6 wherein said radius offset is about 0.1 mm.

8. The friction one-way clutch as recited in claim 2 further comprising at least one spring positioned between at least one of said tapered wedges and at least one of said at least one ramp.

9. The friction one-way clutch as recited in claim 2 further comprising a stator, wherein said friction one-way clutch is positioned within said stator.

10. The friction one-way clutch as recited in claim 2 wherein said outer race is stamped.

11. The friction one-way clutch as recited in claim 2 wherein said inner race is stamped.

12. The friction one-way clutch as recited in claim 2 wherein said wedge ring is stamped.

13. The friction one-way clutch as recited in claim 2 further comprising a plurality of splines distributed around said inner edge of said inner race.

14. The friction one-way clutch as recited in claim 2 further comprising a circular shaft housing integral with said inner race and projecting substantially from said inner race and having an outer surface and an inner surface, wherein a plurality of splines are formed along the length of said inner surface of said circular shaft housing.

15. A friction one way clutch, which is arranged in a stator comprising:
a torque converter stator; and,
a one-way friction clutch comprising:
a flat outer race, said outer race having an inner circumference and an outer circumference and fixed attached to said stator;
a flat wedge ring, said wedge ring having an offset radius and at least one tapered wedge that forms at least part of an inner circumference of said wedge ring and an outer circumference having a gap, wherein said wedge ring forms an interference fit with said inner perimeter of said outer race; and,
a flat inner race, said inner race having an inner circular edge and an outer edge, wherein said outer edge is generally round and formed into at least one tapered ramp; and,
wherein said at least one ramp of said inner race contacts at least one of said at least one tapered wedge to form at least one friction point when said inner race is rotated in one direction; and,
wherein said one-way friction clutch is positioned within said stator.

16. The friction one-way clutch as recited in claim 15 wherein said wedge ring is shaped according to the formula μᵢ<tan θ<μₒrₒ/rᵢ in which θ is a wedge angle formed by the rotation of said wedge ring in the lockup direction to said outer race, μₒ is the coefficient of friction between said wedge ring and said outer race, μᵢ is the coefficient of friction between said wedge ring and said inner race, rₒ is the radius of said wedge ring, rᵢ is the inner radius of said wedge ring.

17. The friction one-way clutch as recited in claim 16 wherein said coefficient of friction μₒ ranges from about 0.05 to about 0.25, said outer radius ranges from about 50 mm to about 175 mm, and said inner radius ranges from about 25 mm to about 150 mm.

18. The friction one-way clutch as recited in claim 15 wherein said at least one tapered wedge is a plurality of tapered wedges.

19. The friction one-way clutch as recited in claim 15 wherein said at least one ramp is a plurality of ramps.

20. The friction one-way clutch as recited in claim 15 wherein said offset radius ranges from about 0.05 mm to about 0.2 mm.

21. The friction one-way clutch as recited in claim 20 wherein said radius offset is about 0.1 mm.

22. The friction one-way clutch as recited in claim 15 further comprising at least one spring positioned between at least one of said tapered wedges and at least one of said at least one ramp.

23. The friction one-way clutch as recited in claim 15 wherein said outer race is stamped.

24. The friction one-way clutch as recited in claim 15 wherein said inner race is stamped.

25. The friction one-way clutch as recited in claim 15 wherein said wedge ring is stamped.

26. The friction one-way clutch as recited in claim 15 further comprising a spring placed between at least one of said at least one wedge and at least one ramp.

27. The friction one-way clutch as recited in claim 15 further comprising a plurality of splines distributed around said inner edge of said inner race.

28. The friction one-way clutch as recited in claim 15 further comprising a circular shaft housing integral with said inner race and projecting substantially from said inner race and having an outer surface and an inner surface, wherein a plurality of splines are formed along the length of said inner surface of said circular shaft housing.
